(19) United States
(12) Patent Application Publication
(10) Pub. No.: US 2003/0208542 A1
(43) Pub. Date: Nov. 6, 2003

(54) Software test agents

(75) Inventors: Gary Deming, Eden Prairie, MN (US); Steven Shaw, Savage, MN (US)

Correspondence Address: Schwegman, Lundberg,, Woessner & Kluth, P.A., P.O. Box 2938, Minneapolis, MN, 55402, US

(73) Assignee: TestQuest, Inc.

(21) Appl. No.: 10/322,824

(22) Filed: Dec. 18, 2002

Related U.S. Application Data
(60) Provisional application No. 60/377,515, filed on May 1, 2002.

(51) Int. Cl. G06F 15/16

(52) U.S. Cl. 709/205

(57) ABSTRACT

A computerized method and system for testing an information-processing system-under-test. This includes using few system-under-test resources by driving native operating software stimulation commands to a system-under-test software test agent over a platform-neutral, open-standard connection, capturing an output from the system-under-test for comparison with an expected output for success determination. This also includes the use of a host testing system having a target interface for interfacing with a system-under-test by issuing a stimulation instruction to the target interface, processing the instruction to derive a stimulation signal for the system-under-test, and sending the signal to the software test agent running in the system-under-test unit. The use of the software test agent includes executing a set of test commands to derive and issue a stimulation input to the native operating software of the system-under-test based on a stimulation signal received from the target interface.

### RELATED APPLICATION

This application claims priority to U.S. Provisional Application serial No. 60/377,515 (entitled AUTOMATIC TESTING APPARATUS AND METHOD, filed May 1, 2002) which is herein incorporated by reference.

This application is related to U.S. Patent Application entitled METHOD AND APPARATUS FOR MAKING AND USING TEST VERBS filed on even date herewith, to U.S. patent application entitled NON-INTRUSIVE TESTING SYSTEM AND METHOD filed on even date herewith, and to U.S. patent application Ser. No. entitled METHOD AND APPARATUS FOR MAKING AND USING WIRELESS TEST VERBS filed on even date herewith, each of which are incorporated herein by reference.

### FIELD OF THE INVENTION

This invention relates to the field of computerized test systems and more specifically to a method and system for testing an information-processing device using minimal information-processing device resources.

### BACKGROUND OF THE INVENTION

An information-processing system is tested several times over the course of its life cycle, starting with its initial design and being repeated every time the product is modified. Typical information-processing systems include personal and laptop computers, personal data assistants (PDAs), cellular phones, medical devices, washing machines, wristwatches, pagers, and automobile information displays. Many of these information-processing systems operate with minimal amounts of memory, storage, and processing capability.

Because products today commonly go through a sizable number of revisions and because testing typically becomes more sophisticated over time, this task becomes a larger and larger proposition. Additionally, the testing of such information-processing systems is becoming more complex and time consuming because an information-processing system may run on several different platforms with different configurations, and in different languages. Because of this, the testing requirements in today's information-processing system development environment continue to grow.

For some organizations, testing is conducted by a test engineer who identifies defects by manually running the product through a defined series of steps and observing the result after each step. Because the series of steps is intended to both thoroughly exercise product functions as well as re-execute scenarios that have identified problems in the past, the testing process can be rather lengthy and time-consuming. Add on the multiplicity of tests that must be executed due to system size, platform and configuration requirements, and language requirements, and one will see that testing has become a time consuming and extremely expensive process.

In today's economy, manufacturers of technology solutions are facing new competitive pressures that are forcing them to change the way they bring products to market. Being first-to-market with the latest technology is more important than ever before. But customers require that defects be uncovered and corrected before new products get to market. Additionally, there is pressure to improve profitability by cutting costs anywhere possible.

Product testing has become the focal point where these conflicting demands collide. Manual testing procedures, long viewed as the only way to uncover product defects, effectively delay delivery of new products to the market, and the expense involved puts tremendous pressure on profitability margins. Additionally, by their nature, manual testing procedures often fail to uncover all defects.

Automated testing of information-processing system products has begun replacing manual testing procedures. The benefits of test automation include reduced test personnel costs, better test coverage, and quicker time to market. However, an effective automated testing product often cannot be implemented. One common reason for the failure of testing product implementation is that today's testing products use large amounts of the resources available on a system-under-test. When the automated testing tool consumes large amounts of available resources of a system-under-test, these resources are not available to the system-under-test during testing, often causing false negatives. Because of this, development resources are then needlessly consumed attempting to correct non-existent errors. Accordingly, conventional testing environments lack automated testing systems and methods that limit the use of system-under-test resources.

What is needed is an automated testing system and method that minimizes the use of system-under-test resources.

### SUMMARY OF THE INVENTION

The present invention provides a computerized method and system for testing an information processing system-under-test unit. The computerized method and system perform tests on a system-under-test using very few system-under-test unit resources by driving system-under-test unit native operating software stimulation commands to the system-under-test unit over a platform-neutral, open-standard connectivity interface and capturing an output from the system-under-test unit for comparison with an expected output.

In some embodiments, the computerized method for testing an information-processing system-under-test unit includes the use of a host testing system unit. In one such embodiment, the host testing system unit includes a target interface for interfacing with a system-under-test unit having native operating software. The system-under-test unit native operating software is used for controlling field operations.

In some embodiments, the use of the target interface includes issuing a target interface stimulation instruction to the target interface, processing the target interface stimulation instruction to derive a stimulation signal for the system-under-test unit, and sending the stimulation signal from the host testing system unit's target interface to the software test agent running in the system-under-test unit.

In some embodiments, the use of the software test agent includes executing a set of test commands to derive and issue a stimulation input to the native operating software of the system-under-test unit. In various embodiments, the stimulation input to the native operating software of the system-under-test unit is based on a stimulation signal received from the host testing system unit's target interface.

In some embodiments of the method, a system-under-test unit output is captured by the host testing system unit. This captured output is then compared in the host testing system unit to expected output to determine a test result.

In some embodiments, the computerized system for testing a function of an information-processing system-under-test includes a host testing system unit and a system-under-test unit. In one such embodiment, the host testing system unit includes a memory, a target interface stored in the memory having commands for controlling stimulation signals sent to the system-under-test unit, an output port, and an input port. The system-under-test unit of this embodiment includes a memory, native operating software stored in the memory, a software test agent stored in the memory, an input port, and an output port. The software test agent stored in the memory includes commands for stimulating the system-under-test unit in response to stimulation signals received from the host testing system unit's target interface. Additionally, this embodiment includes a connector for carrying signals from the host testing system unit output port to the system-under-test unit input port and a connector for carrying signals from the system-under-test unit output port to the host testing system unit input port.

In another embodiment, the system includes a host testing system unit, a system-under-test unit, and one or more connections between the host testing system unit and the system-under-test unit. This system embodiment further includes a target interface on the host testing system unit having a platform-neutral, open-standard connectivity interface for driving stimulation signals over the one or more connections to the system-under-test unit. Additionally, this embodiment includes a software test agent on the system-under-test unit that is used for parsing and directing stimulation signals received from the target interface to the native operating software of the system-under-test unit.

Another embodiment of the system includes a software test agent for execution on an information-processing system-under-test unit. In one such embodiment, the system-under-test unit has native operating software that controls field functions of the system-under-test unit. In one such embodiment, the software test agent includes a platform-neutral, open-standard connectivity interface and a set of commands that parse stimulation signals received over the platform-neutral, open-standard connectivity interface and directs stimulations to the native operating software.

### BRIEF DESCRIPTION OF THE DRAWINGS

FIG. 1 is a flow diagram of a method 100 according to an embodiment of the invention.

FIG. 2 shows a block diagram of a system 200 according to an embodiment of the invention.

FIG. 3 is a schematic diagram illustrating a computer readable media and associated instruction sets according to an embodiment of the invention.

FIG. 4 shows a block diagram of a system 400 according to an embodiment of the invention.

FIG. 5 shows a block diagram of a system 500 according to an embodiment of the invention.

FIG. 6 shows a block diagram of a system 600 according to an embodiment of the invention.

FIG. 7 shows a block diagram of a system 700 according to an embodiment of the invention.

FIG. 8 shows a block diagram of a system 800 according to an embodiment of the invention.

### DETAILED DESCRIPTION OF THE INVENTION

In the following detailed description, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

The present invention discloses a system and method for stimulating a target device (for example, in a manner simulating human interaction with the target device) and receiving output from a stimulated target device that corresponds to device output (e.g., that provided for the human user). A host system provides the stimulation and receives the output from the target device. The target device includes a software agent that is minimal in size and is not invasive to the target device's native software. In some embodiments, the software agent is a common piece of software used across a family of devices, and thus it can be easily added to the various respective software sets for each device and the host computer software can easily interface with the various devices' software agents. (E.g., a product line containing a number of similar but unique mobile telephones (a mobile phone, as used herein, includes a cellular phone, a CDMA (Code Division Multiple Access) phone, a satellite phone, a cordless phone, and like technologies), personal data assistants (PDAs), washing machines, microwave ovens, automobile electronics, airplane avionics, etc.). When executing in a multi-task target device, a software agent is implemented, in some embodiments, as a software agent task. Because the software agent is the same across all products, a single, well-defined, common interface is provided to the host system. In some embodiments, the host system is a testing system for the target device (which is called a system-under-test).

In some embodiments, a target device is stimulated by simulating actions of a human user, including key and button pressing, touching on a touch screen, and speaking into a microphone. In some embodiments, output from a stimulated target device is received as a human does including capturing output from the device including visual, audio, and touch (e.g., vibration from a pager, wristwatch, mobile phone, etc.). In some embodiments, the target device includes a remote weather station, a PDA, a wristwatch, a mobile phone, a medical vital sign monitor, and a medical device.

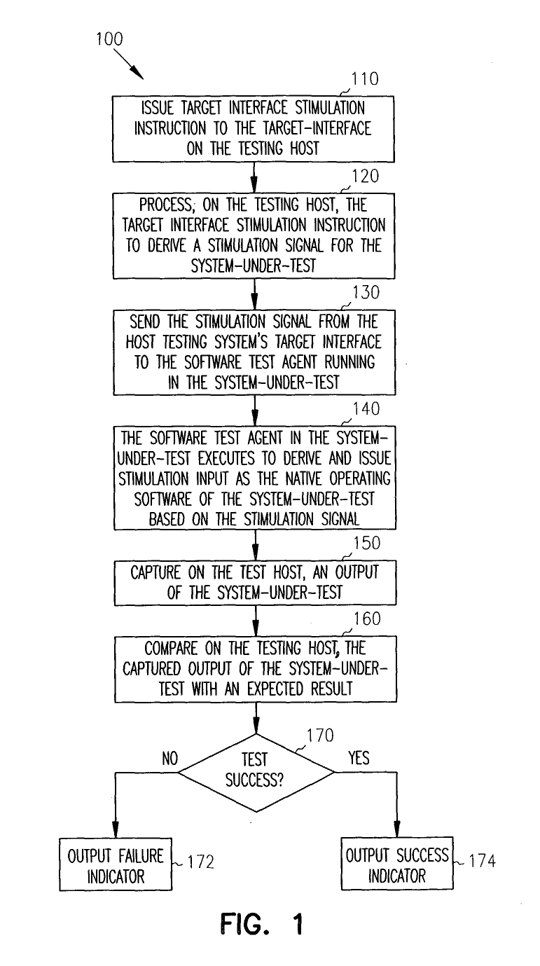

FIG. 1 shows a flow diagram of a computerized method 100 for testing a function of a system-under-test unit. As used herein, a unit is a subsystem of a system implementing the computerized method 100 that is capable of operating as an independent system separate from the other units included in the system implementing the computerized method 100. Various examples of a unit include a computer such as a PC or specialized testing processor, or a system of computers such as a parallel processor or an automobile having several computers each controlling a portion of the operation of the automobile.

In some embodiments, the computerized method 100 includes an information-processing system-under-test unit having native operating software for controlling field operations. As used herein, field operations are operations and functions performed by the system-under-test unit during normal consumer operation. Field operations are in contrast to lab operations that are performed strictly in a laboratory or manufacturing facility of the system-under-test unit manufacturer. In some embodiments, the computerized method also includes a host testing system unit having a target interface for connecting to the system-under-test unit.

In various embodiments, a host testing system unit includes a personal computer, a personal data assistant (PDA), or an enterprise-class computing system such as a mainframe computer.

In various embodiments, the information-processing system-under-test unit includes a device controlled by an internal microprocessor or other digital circuit, such as a handheld computing device (e.g., a personal data assistant or “PDA”), a cellular phone, an interactive television system, a personal computer, an enterprise-class computing system such as a mainframe computer, a medical device such as a cardiac monitor, or a household appliance having a “smart” controller.

In some embodiments, the computerized method 100 operates by issuing 110 a target interface stimulation instruction to the target interface on the host testing system unit. Exemplary embodiments of such instructions are described in Appendix A which is incorporated herein. The target interface stimulation instruction is then processed 120 to derive a stimulation signal for the system-under-test unit and the signal is sent 130 from the host testing system unit's target interface to the software test agent running in the system-under-test unit. In this embodiment, the method 100 continues by executing 140 a set of test commands in the software test agent to derive and issue a stimulation input to the native operating software of the system-under-test unit based on the stimulation signal, capturing 150, in the host testing system unit, an output of the system-under-test unit, and comparing 160 the captured output in the host testing system unit to an expected result.

In some embodiments, the computerized method 100 continues by determining 170 if the test was successful based on the comparing 160 and outputting a success indicator 174 or failure indicator 172 from the host testing system unit based on the determination 170 made.

An issued 110 stimulation instruction is processed 120, sent 130, and executed 140 by the system-under-test unit to cause specific actions to be performed by the system-under-test unit. In various embodiments, these specific actions include power on/off, character input, simulated key or button presses, simulated and actual radio signal sending and reception, volume adjustment, audio output, number calculation, and other field operations.

In some embodiments of the computerized method 100, the captured output 150 from the system-under-test unit includes output data. In various embodiments, this captured 150 output data includes visual output data, audio output data, radio signal output data, and text output data.

In some embodiments, the processing 120 of a target interface stimulation instruction on the host testing system unit includes processing 120 a stimulation instruction to encode the instruction in Extensible Markup Language (XML) to be sent 130 to the software test agent on the system-under-test unit. In some embodiments, this processing 120 includes parsing the stimulation instruction into commands executable by the native operating software on the system-under-test unit using a set of XML tags created for a specific implementation of the computerized method 100. In some other embodiments, this processing 130 includes parsing the stimulation instruction into commands that can be interpreted by the software test agent on the system-under-test unit.

In some embodiments, the processed 120 stimulation instruction encoded in XML is then embodied in and sent 130 over a platform-neutral, open-standard connectivity interface between the host testing system unit and the system-under-test unit. In various embodiments, the platform-neutral, open-standard connectivity interface between the host testing system unit and the system-under-test unit includes interface technologies such as Component Object Model (COM), Distributed Component Object Model (DCOM), Simple Object Access Protocol (SOAP), Ethernet, Universal Serial Bus (USB), .net® (registered trademark owned by Microsoft Corporation), Electrical Industries Association Recommended Standard 232 (RS-232), and Bluetooth™.

In some embodiments, a captured 150 from a system-under-test unit on a host testing system unit is stored in memory. For example, if an audio output is captured 150, the audio output is captured 150 and stored in memory as an audio wave file (*.wav). Another example if the captured 150 output from the system-under-test unit is a visual output, the visual output is captured 150 and stored in memory as a bitmap file (*.bmp) on the host testing system unit.

In some embodiments, the output success 174 and failure 172 indicators include boolean values. In various other embodiments, the indicators, 172 and 174, include number values indicating a comparison match percentage correlating to a percentage of matched pixels in a captured visual output with an expected output definition and text values indicating a match as required by a specific implementation of the computerized method 100.

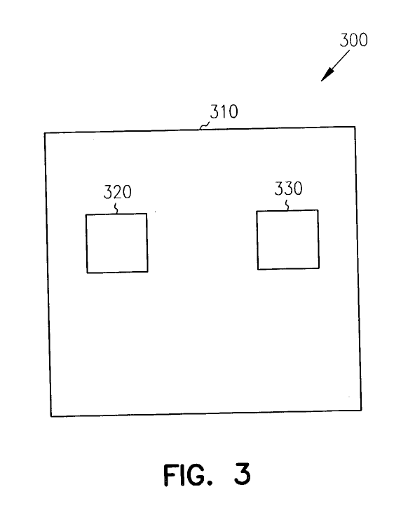

FIG. 3 is a schematic drawing of a computer-readable media 310 and an associated host testing system unit target interface instruction set 320 and system-under-test unit software test agent instruction set according to an embodiment of the invention. The computer-readable media 310 can be any number of computer-readable media including a floppy drive, a hard disk drive, a network interface, an interface to the internet, or the like. The computer-readable media can also be a hard-wired link for a network or be an infrared or radio frequency carrier. The instruction sets, 320 and 330, can be any set of instructions that are executable by an information-processing system associated with the computerized method discussed herein. For example, the instruction set can include the method 100 discussed with respect to FIGS. 1. Other instruction sets can also be placed on the computer-readable medium 310.

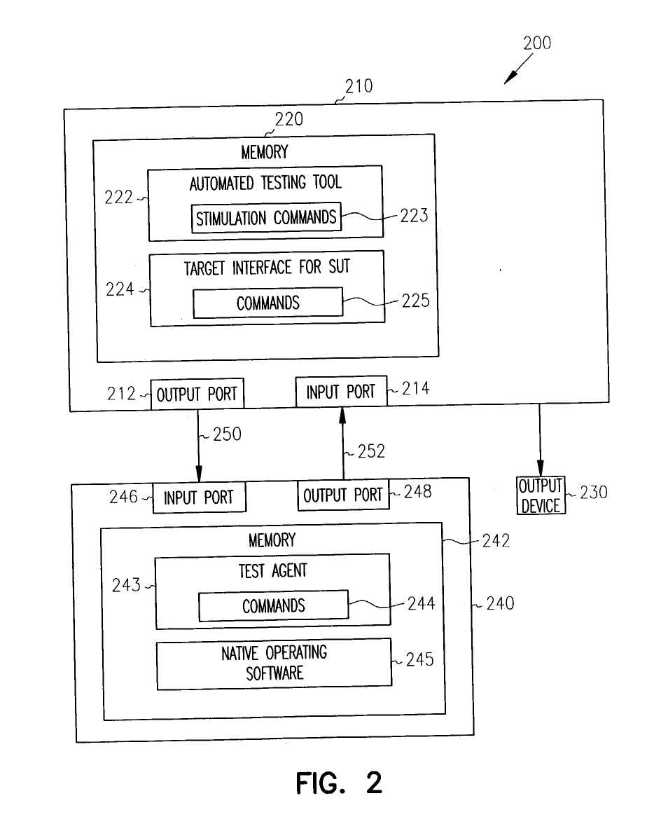

FIG. 2 shows a block diagram of a system 200 according to an embodiment of the invention. In some embodiments, a system 200 includes a host testing system unit 210 and a system-under-test unit 240. In some embodiments, a host testing system unit 210 includes a memory 220 holding an automated testing tool 222 having a set of stimulation commands 223. An example of an automated testing tool 222 having a set of stimulation commands 223 is TestQuest Pro™ (available from TestQuest, Inc. of Chanhassen, Minn.). Various examples of host testing system units and system-under-test unit are described above as part of the method description.

In some embodiments, the memory 220 also holds a target interface 224 having commands 225 for controlling stimulation signals sent to the system-under-test unit 240 software test agent 243. In some embodiments of system 200, a host testing system unit 210 of a system 200 has an output port 212, an input port 214, and an output device 230. In some embodiments, the system-under-test unit 240 of a system 200 includes a memory 242 holding a software test agent 243 having commands 244 for stimulating the system-under-test unit 240, and native operating software 245 for controlling field operations. Additionally, in some embodiments, a system-under-test unit has an input port 246 and an output port 248. In some embodiments, the output port of the host testing system unit 210 is coupled to the input port 246 of the system-under-test unit 240 using a connector 250 and the output port 248 of the system-under-test unit 240 is coupled to the input port 214 of the host testing system unit 210 using a connector 252.

In various embodiments, the stimulation commands 223 include power on/off, character input, simulated key or button presses, simulated and actual radio signal sending and reception, volume adjustment, audio output, number calculation, and other field operations.

In some embodiments, the target interface 224 of the host testing system unit includes commands 225 for controlling stimulation signals sent to the system-under-test unit 240 software test agent 243. In some embodiments, the commands 225 for controlling the stimulation signals includes commands for encoding issued stimulation commands in XML and for putting the XML in a carrier signal that is sent over a platform-neutral, open-standard connectivity interface between the host testing-system unit and the system-under-test unit using host testing system unit 210 output port 212, connector 250 and system-under-test unit 240 input port 246.

In various embodiments, the platform-neutral, open-standard connectivity interface between the host testing system unit and the system-under-test unit includes software interface technologies such as Component Object Model (COM), Distributed Component Object Model (DCOM), and/or Simple Object Access Protocol (SOAP). In various embodiments, the hardware interface technologies include Ethernet, Universal Serial Bus (USB), Electrical Industries Association Recommended Standard 232 (RS-232), and/or wireless connections such as Bluetooth™.

In some embodiments, the software test agent 243 on the system-under-test unit 240 includes commands 244 for stimulating the system-under-test unit 240. These commands 244 operate by receiving from system-under-test unit 240 input port 246, a stimulation signal sent by the target interface 224 of the host testing system unit and converting the signal to native operating software 245 commands. The converted native operating software 245 commands are then issued to the native operating software 245.

In some embodiments, software test agent 243 is minimally intrusive. As used herein, a minimally intrusive software test agent 243 has a small file size and uses few system resources in order to reduce the probability of the operation system-under-test 240 being affected by the software test agent 243. In one embodiment of a minimally intrusive software test agent for a Win32 implementation, the file size is approximately 60 kilobytes. In some such embodiments and other embodiments of the minimally intrusive software test agent 243, the software test agent 243 receives signals from the host testing system 210 causing the software test agent 243 to capture an output of the system-under-test from a memory device resident on the system-under-test 240 such as memory 242. In various embodiments, different minimally intrusive software test agents 243 exist that are operable on several different device types, makes, and models. However, these various embodiments receive identical signals from a host-testing-system 210 and cause the appropriate native operating system 245 command to be executed depending upon the device type, make, and model the software test agent 243 is operable on. In some embodiments, a minimally intrusive software test agent 243 is built into the native operating software 245 of the system-under-test 240. In other embodiments, a minimally intrusive software test agent 243 is downloadable into the native operating software 245 of the system-under-test 240. In some other embodiments, a minimally intrusive software test agent 243 is downloadable into the memory 242 of the system-under-test 240.

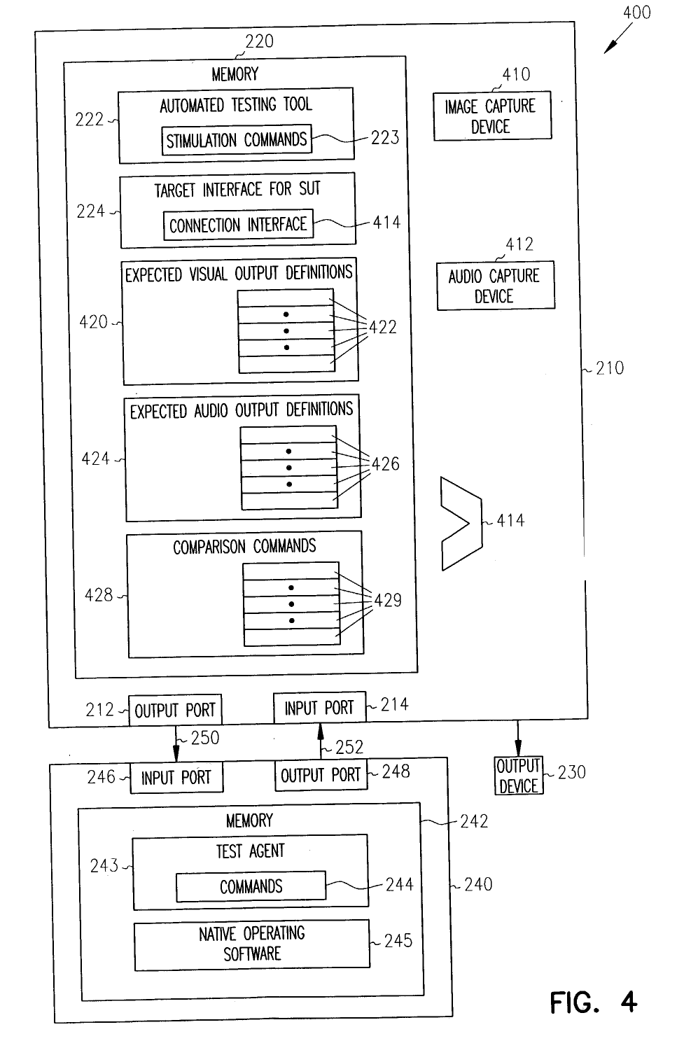

Another embodiment of the system 200 for testing a function of an information-processing system-under-test unit 240 is shown in FIG. 4. The system 400 is very similar to the system 200 shown in FIG. 2. For the sake of clarity, as well as the sake of brevity, only the differences between the system 200 and the system 400 will be described. The system 400, in some embodiments, includes expected visual output definitions 422, expected audio output definitions 426, and comparison commands 429 all stored in the memory 220 of the host testing system unit. Additionally, system 400 host testing system unit includes an image capture device 410, an audio capture device 412, and a comparator 414.

In some embodiments, system 400 operates by capturing a visual output from the system-under-test unit 240 output port 248 using the image capture device 410. In one such embodiment, the image capture device 410 captures a system-under-test unit 240 visual output transmitted over connector 252 to the host testing system unit 210 input port 214. In some embodiments, the host testing system unit 210 compares a captured visual output of the system-under-test unit 240 using one or more comparison commands 429, one or more expected visual output definitions 422, and the comparator 244. In some embodiments, the system outputs a comparison result through the output device 230.

In some embodiments, system 400 operates by capturing an audio output from the system-under-test unit 240 output port 248 using the audio capture device 412. In one such embodiment, the audio capture device 412 captures a system-under-test unit 240 audio output transmitted over connector 252 to the host testing system unit 210 input port 214. In some embodiments, the host testing system unit 210 compares a captured audio output of the system-under-test unit 240 using one or more comparison commands 429, one or more expected audio output definitions 426, and the comparator 244. In some embodiments, the system outputs a comparison result through the output device 230.

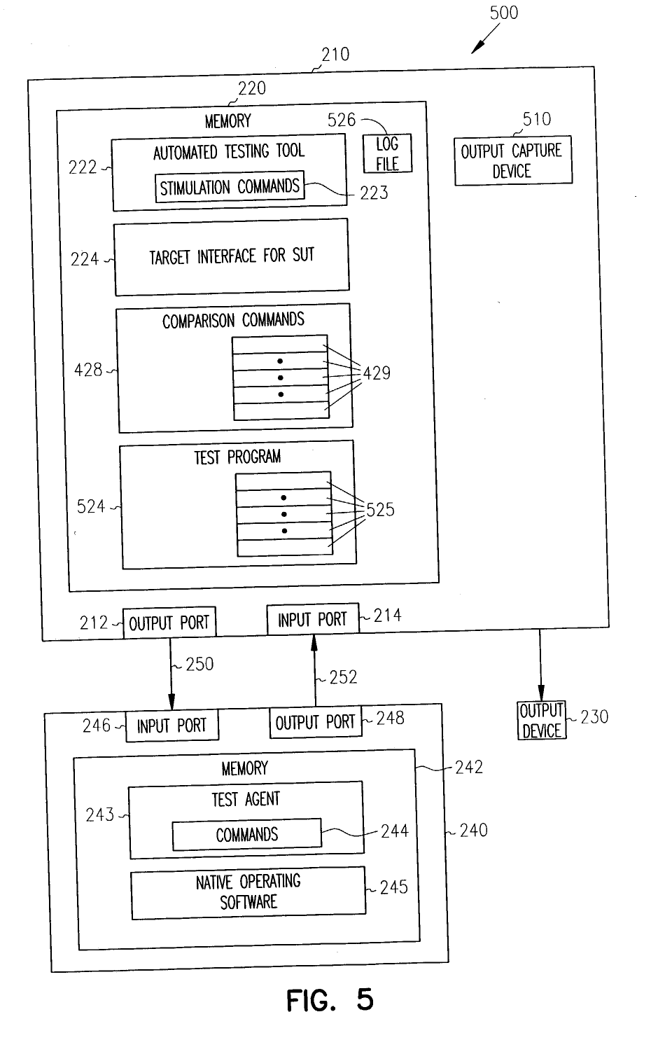

Another embodiment of the system 200 for testing a function of an information-processing system-under-test unit 240 is shown in FIG. 5. The system 500 is very similar to the system 200 shown in FIG. 2. Again, for the sake of clarity, as well as the sake of brevity, only the differences between the system 200 and the system 500 will be described. The system 500, in some embodiments, includes one or more test programs 525 and a log both stored in the memory 220. Some further embodiments of a system 500 include an output capture device.

In some embodiments, a test program 525 consists of one or more stimulation commands 223 that, when executed on the host testing system unit 210, perform sequential testing operations on the system-under-test unit. In one such embodiment, a test program 525 also logs testing results following stimulation command 223 execution and output capture using output capture device 510 in log file 526.

In some embodiments, output capture device 510 is used to capture system-under-test unit 240 output signals communicated over connector 252 from system-under-test unit 240 output port 248 to host testing system unit 210 input port 214. This output capture device 510 is a generic output data capture device. It is to be contrasted with the audio output 412 and image output 410 capture devices shown in FIG. 4.

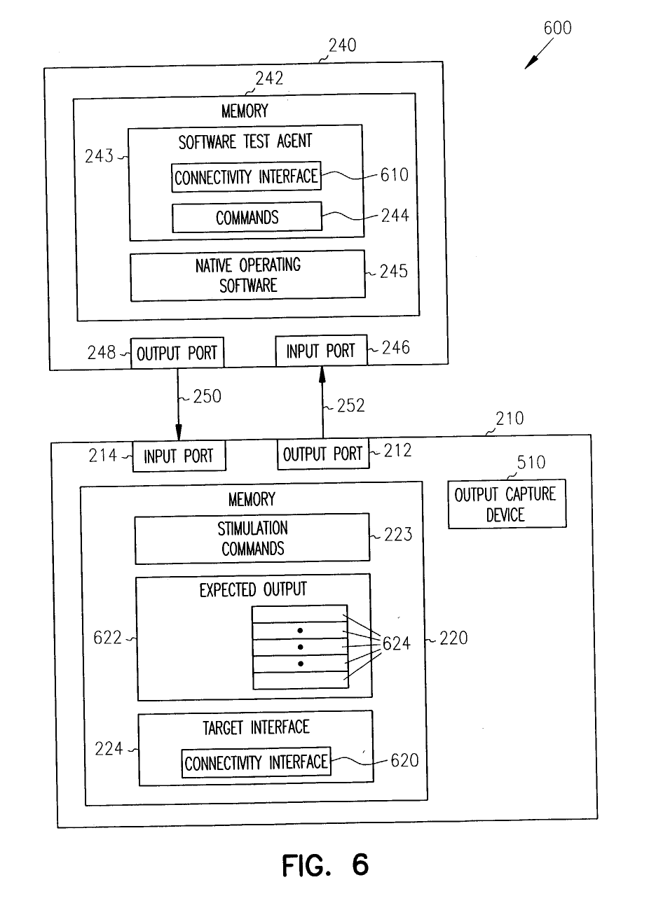

Another embodiment of the invention for testing a function of an information-processing system-under-test unit 240 is shown in FIG. 6. The system 600 is very similar to the system 200 shown in FIG. 2. Again, for the sake of clarity, as well as the sake of brevity, only the differences between the system 200 and the system 600 will be described. The system 600, in some embodiments, includes one or more expected output definitions 624 stored in the memory 220 of the system-under-test unit 210. Additionally, some embodiments of the target interface 224 of the host testing system unit include a connectivity interface 620. In addition, in some embodiments of the system 600, a connectivity interface 610 is included as part of the software test agent on the system-under-test unit 243.

The expected output definitions 624 included in some embodiments of the system 600 include generic expected output definitions. For example, the definitions 624 in various embodiments include text files, audio files, and image files.

The connectivity interfaces, 610 and 620, of various embodiments of the system 600 include the interfaces discussed above in the method discussion.

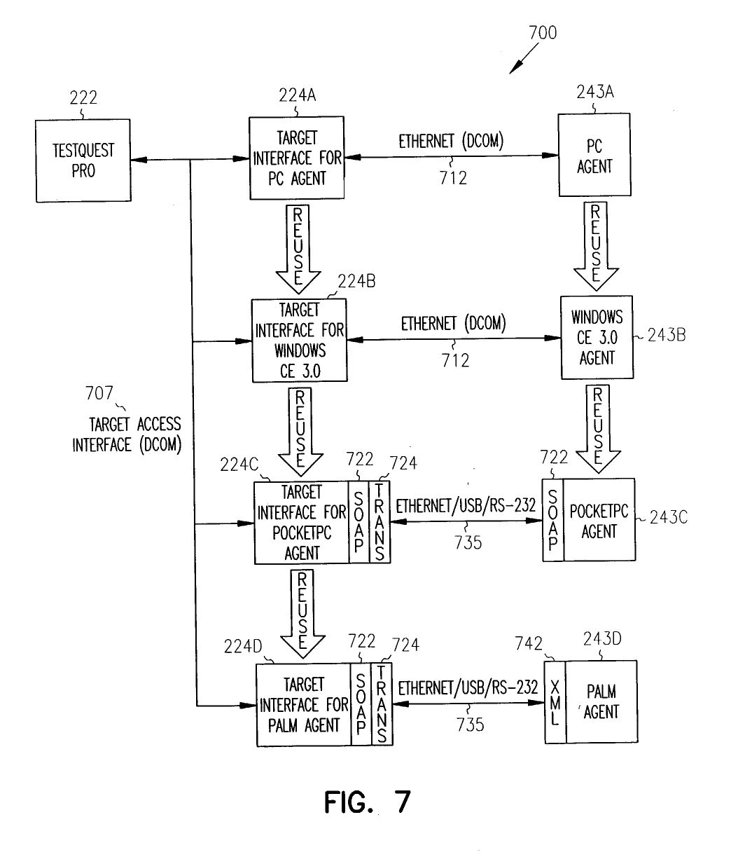

FIG. 7 shows a block diagram of a larger embodiment of a system for testing a function of an information-processing system-under-test unit. The embodiment shown includes an automated testing tool 222 communicating using a DCOM interface 707 with multiple host testing system unit target interfaces 224A-D. Each target interface 224A-D is a target interface customized for a specific type of system-under-test unit software test agent 243A-D. FIG. 7 shows various embodiments of the target interfaces 224A-D communicating with system-under-test unit software test agents 243A-D. For example, the target interface 224A for communicating with a Windows PC software test agent 243A is shown using an Ethernet connection 712 communicating using a DCOM interface. Another example, the target interface 224D for communicating with a Palm software test agent 243D is shown using SOAP 722 transactions 724 over a connection 735 that, in various embodiments, includes Ethernet, USB, and RS-232 connections. Additionally in this embodiment, an XML interpreter 742 is coupled to the software test agent 243D.

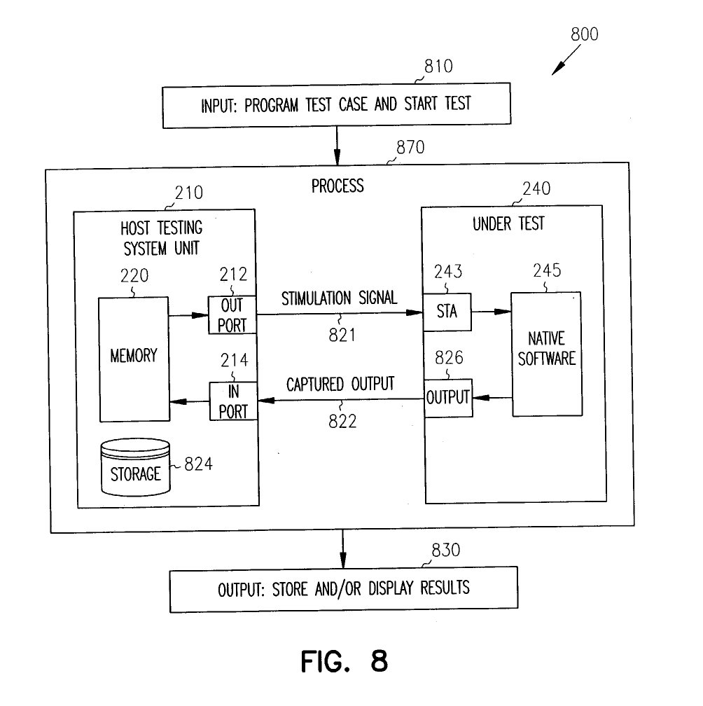

FIG. 8 shows a block diagram of a system 800 according to an embodiment of the invention. This block diagram gives a high-level overview of the operation of an embodiment of system 800. In some embodiments, a system 800 includes an input 810, a process 820, and an output 830. In some embodiments, the input includes a test case and initiation of the process 820. In some embodiments, the process 820 includes a host testing system unit 210 having a memory 220, an output port 212, an input port 214, and storage 824. Further, this embodiment of the process 820 also includes a system-under-test unit 240 having a software test agent 243, native operating software 245, and an output port 826. In some embodiments, the system 800 requires the input 810 of a test case and initiation of the process 820. The test case is executed from the host testing system unit's memory 220. The test program drives a stimulation signal 821 through the output port 212 of host testing system unit 210 to the software test agent 243 in system-under-test unit 240. The software test agent then stimulates the native operating software 245 of the system-under-test unit 240. The system-under-test unit 240 then responds and the output is captured 822 from output port 826 of the system-under-test unit 240. The process 820 stores the output 830 in memory 220 or storage 824.

Thus, the present invention provides a minimally invasive software add-on, the software test agent, which is used in the system-under-test unit to test a function of the system-under-test unit. A software test agent allows testing of a system-under-test unit without causing false testing failure by using minimal system-under-test unit resources.

### CONCLUSION

As shown in FIG. 1, one aspect of the present invention provides a computerized method 100 for testing an information-processing system-under-test unit. The method includes a host testing system unit having a target interface for connecting to the system-under-test unit, the system-under-test unit having native operating software for controlling field operations. In some embodiments, the method 100 includes issuing 110 a target interface stimulation instruction to the target interface on the testing host, processing 120 the target interface stimulation instruction to derive a stimulation signal for the system-under-test unit, sending 130 the stimulation signal from the host testing system unit's target interface to the software test agent running in the system-under-test unit, and executing 140 a set of test commands by the software test agent to derive and issue a stimulation input to the native operating software of the system-under-test unit based on the sent stimulation signal. Some embodiments of the invention also include capturing 150, in the host testing system unit, an output of the system-under-test unit, comparing 160 the captured output in the host testing system unit to an expected result for determining 170 test success, and outputting 172 a failure indicator or outputting 174 a success indicator. In some embodiments, the capturing 150 of a system-under-test unit output includes capturing a visual output. In other embodiments, the capturing 150 of a system-under-test unit output includes an audio output. In some embodiments, the processing 120 the target interface stimulation instruction to derive a stimulation signal for the system-under-test unit includes encoding in the stimulation signal, the stimulation instruction in Extensible Markup Language (XML). In various embodiments, the interface between the target interface and the software test agent includes a platform-neutral, open-standard interface.

Another aspect of the present invention is shown in FIG. 3. In some embodiments, the invention provides a computer readable media 310 that includes target interface instructions 320 and software test agent instructions coded thereon, that when executed on a suitably programmed computer and on a suitably programmed information-processing system-under-test executes the above methods. Other embodiments include target interface instructions 320 encoded on one computer readable media 310 and software test agent instructions 330 encoded on a separate computer readable media 310.

FIG. 2 shows a block diagram of an embodiment of a system 200 for testing a function of an information-processing system-under-test unit 240 using a host testing system unit 210. In various embodiments, the host testing system unit 210 includes a memory 220 holding an automated testing tool 222 having stimulation commands 223 and a target interface 224 for interfacing with a system-under-test unit 240 test agent 243. In some embodiments, the target interface 224 includes commands 225 for controlling stimulation signals sent to the system-under-test unit 240 software test agent 243. In some embodiments, the host testing system 210 also includes an output port 212 and an input port 214. Also shown in FIG. 2, some embodiments of a system 200 includes a system-under-test unit 240 having a memory 242 holding a software test agent 243 holding native operating software 245 and a software test agent 243. Some embodiments of the software test agent 243 include commands 244 for stimulating the system-under-test unit, wherein the software test 243 agent receives stimulation signals from the host testing system unit's 210 target interface 224. Additional embodiments of a system 200 system-under-test unit 240 include an input port 246 connected with a connector 246 to the output port 212 of the host testing system 210 and an output port 248 connected with a connector 252 to the host testing system 210 input port 214. In some embodiments, connector 250 carries stimulation signals from the host testing system unit 210 target interface 224 to the system-under-test unit 240 software test agent 243. In some embodiments, connector 252 carries output signals from the system-under-test unit 240 to the host testing system unit 210 for use in determining test success or failure. In some embodiments, the host testing system unit 210 of the computerized system 200 also includes an output device 230 for providing a test result indicator. In some embodiments, the computerized system's 200 system-under-test unit 240 software test agent 243 includes only commands 244 for parsing stimulation signals received from the host testing system unit 210 and for directing stimulation to the native operating software 245 on the system-under-test unit 240.

FIG. 4 shows a block diagram of another embodiment of a system 400 according to the invention. In some embodiments, a system 400 host testing system unit 210 includes an image capture device 410 for capturing visual output signals from the system-under-test unit 240. These visual output signals are received from the output port 248 of the system-under-test unit 240 and carried in a carrier wave over connector 252 to the input port 214 of the host testing system unit 210. In some embodiments, a host testing system 210 also includes expected visual output definitions 422 stored in the memory 220 and a comparator 414 for comparing captured visual output signals from the system-under-test unit 210 with one or more expected visual output definitions 422. In some embodiments, a system 400 host testing system unit 210 includes an audio output capture device 412 for capturing audio output signals from the system-under-test unit 240. These audio output signals are received from the output port 248 of the system-under-test unit 240 and carried in a carrier wave over connector 252 to the input port 214 of the host testing system unit 210. In one such embodiment, the host testing system also includes expected audio output definitions 426 stored in the memory 220 and a set of comparison commands 429 stored in the memory 220 for comparing the captured audio output with one or more expected audio output definitions 426.

FIG. 5 shows a block diagram of another embodiment of a system 500 for testing a function of an information-processing system-under-test unit. In some embodiments, a system 500 includes an output capture device 510 in the host testing system unit 210 for capturing output signals from a system-under-test unit 240. These output signals are received from the output port 248 of the system-under-test unit 240 and carried in a carrier wave over connector 252 to the input port 214 of the host testing system unit 210. In some embodiments, the host testing system unit 210 includes comparison commands 429 for comparing a captured output from the system-under-test unit 240 with an expected output. In some embodiments, the system 500 host testing system unit 210 also includes a test program 524, created using one or more stimulation commands 223, for automatically testing one or more functions of the system-under-test unit 240. In one such embodiment, the host testing system unit 210 includes a log file 526 stored in the memory 220 for tracking test success and failure. Some additional embodiments of the host testing system unit 210 also include an output device 230 for viewing a test program 524 result.

FIG. 6 shows a block diagram of another embodiment of a system 600 according to an embodiment of the invention. In some embodiments, a system 600 includes a software test agent 243 stored in a memory 242 for execution on an information-processing system-under-test unit 240, the system-under-test unit 242 having a native operating software 245, stored in the memory 242, that controls field functions of the system-under-test unit 240. In some embodiments, the software test agent 243 includes a platform-neutral, open-standard connectivity interface 610 and a set of commands 244 for execution on the system-under-test unit 240 that parse stimulation signals received over the platform-neutral, open-standard connectivity interface 610 and directs stimulations to the native operating software 245 of the system-under-test unit 240. In some embodiments, the system-under-test unit 240 outputs data, in response to the stimulation signals, that is captured by the host testing system unit 210 for comparison with an expected output definition 624 to determine a test result.

FIG. 7 shows a block diagram of a system 700 according to an embodiment of the invention. In some embodiments, a system 700 includes a system 500. However, a system 700 includes one or more target interfaces 224A-D for connecting to one or more software test agents 243A-D.

A general aspect of the invention is a system and an associated computerized method for interacting between an information-processing device and a host computer. The host computer has a target interface and the device has a host interface and native operating software that includes a human-user interface for interacting with a human user. The invention includes providing a software agent in the device, wherein the software agent is a minimally intrusive code added to the native operating software. The invention also includes sending a stimulation command from the host computer to the software agent in the device, stimulating the human-user interface of the native operating software of the device by the software agent according to the stimulation command received by the software agent; and receiving, into the host computer, output results of the stimulation of the device. Because the software agent is small and does not interfere with the operation of the native operating software, that native software can provide its normal function as if a human user were providing the stimulation and receiving the results. The host system, in some embodiments, provides a testing function where the devices results in response to the stimulation are compared (in the host computer) to the expected values of the test. Such a system allows software agents to be added to a variety of different devices, wherein the interface seen by the host system is common across those devices. In other embodiments, the host system provides a centralized data gathering and analysis function for one or more remote devices, such as a centralized weather service host computer gathering weather information from a plurality of remote weather station devices (each having a software agent), or a central automobile's central (host) computer gathering information from a plurality of sensor and/or actuator devices (each having a software agent) in an automobile.

In some embodiments, the received output results are representative of a visual output of the device. In some embodiments, the received output results are representative of an audio output of the device.

In some embodiments, the invention is embodied as computer-readable media having instructions coded thereon that, when executed on a suitably programmed computer and on a suitably programmed information-processing system executes one of the methods described above.

It is understood that the above description is intended to be illustrative, and not restrictive. Many other embodiments will be apparent to those of skill in the art upon reviewing the above description. The scope of the invention therefore, should be determined with reference to the appended claims, along with the full scope of equivalents to which such claims are entitled.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computerized method for interacting between a first information-processing device having native operating software that includes a human-interface for interacting with a human user, the method comprising
providing a first target interface on the host computer;
providing a software agent in the first device, the software agent being a minimally intrusive code added to the native operating software of the first device, the software agent provided to interact with the first target interface;
sending a stimulation command from the host computer to the software agent in the first device;
stimulating the human-user interface of the native operating software of the first device by the software agent according to the stimulation command received by the software agent; and
receiving, into the host computer, output results of the stimulation of the first device.

2. The method of claim 1, wherein the host computer is programmed to perform a testing function upon the native operating software of the first device, the method further comprising:
comparing in the host system the received output results to expected values.

3. The method of claim 2, wherein the received output results are representative of a visual output of the device.

4. The method of claim 2, wherein the received output results are representative of an audio output of the first device.

5. A computer-readable media comprising instructions coded thereon that, when executed on a suitably programmed host computer and on a suitably programmed information-processing device, execute the method of claim 1.

6. A computerized method for testing an information-processing system-under-test unit via a host testing system unit having a target interface for connecting to the system-under-test unit, the system-under-test unit having native operating software for controlling field operations, the method comprising:
issuing a target interface stimulation instruction to the target interface;
processing the target interface stimulation instruction to derive a stimulation signal for the system-under-test unit;
sending the stimulation signal from the host testing system unit's target interface to the software test agent running in the system-under-test unit;
executing a set of test commands by the software test agent to derive and issue a stimulation input to the native operating software of the system-under-test unit based on the sent stimulation signal;
capturing, in the host testing system unit, an output of the system-under-test unit; and
comparing the captured output in the host testing system unit to an expected result.

7. The method of claim 6, wherein the comparing the captured output to an expected result is performed to determine test success.

8. The method of claim 6, wherein the captured output includes a visual output from the system-under-test unit.

9. The method of claim 6, wherein the captured output includes an audio output from the system-under-test unit.

10. The method of claim 6, wherein the processing the target interface stimulation instruction to derive a stimulation signal for the system-under-test unit includes encoding the stimulation instruction in Extensible Markup Language (XML) in the stimulation signal.

11. The method of claim 6, wherein the processing the target interface stimulation instruction to derive a stimulation signal for the system-under-test unit includes a Simple Object Access Protocol (SOAP) interface between the target interface and the software test agent.

12. The method of claim 6, wherein the processing the target interface stimulation instruction to derive a stimulation signal for the system-under-test unit includes a Distributed Component Object Model (DCOM) interface between the target interface and the software test agent.

13. A computer-readable media comprising instructions coded thereon that when executed on a suitably programmed computer and on a suitably programmed information-processing system-under-test executes the method of claim 5.

14. A computerized system for testing a function of a first information-processing system-under-test unit, the system comprising:
a host testing system unit that includes:
a memory,
a first target interface stored in the memory, the first target interface including commands for controlling stimulation signals sent to the first system-under-test unit,
a first output port, and
a first input port;
the first system-under-test unit that includes:
a memory,
native operating software stored in the memory,
a software test agent stored in the memory, the software test agent including commands for stimulating the first system-under-test unit, wherein the software test agent receives stimulation signals from the host testing system unit's first target interface,
an input port, and
an output port;
a connector for carrying signals from the host testing system unit first output port to the first system-under-test unit input port; and
a connector for carrying signals from the system-under-test unit first output port to the host testing system unit first input port.

15. The computerized system of claim 14, wherein the host testing system unit further includes:
an output device that provides a test result indicator.

16. The computerized system of claim 14, wherein the software test agent's commands for stimulating the first system-under-test unit include only commands for parsing stimulation signals received from the host testing system unit and for directing stimulation to the native operating software on the first system-under-test unit.

17. The computerized system of claim 14, wherein the connectors for carrying signals include carrier waves transmitted and received using a wireless connectivity technology.

18. The computerized system of claim 14, wherein the host testing system unit further includes an image capture device for capturing visual output signals from the first system-under-test unit.

19. The computerized system of claim 18, wherein the host testing system unit further includes:
expected visual output definitions stored in the memory; and
a comparator for comparing captured visual output signals from a system-under-test unit with one or more expected visual output definitions.

20. The computerized system of claim 14, wherein the host testing system unit further includes:
an audio output capture device for capturing audio output from the system-under-test unit;
expected audio output definitions stored in the memory;
a set of commands stored in the memory for comparing the captured audio output with one or more expected audio output definitions.

21. A computerized system comprising:
a host system, wherein the host system includes a target interface;
an information-processing device having native operating software;
one or more connections between the host system and the information-processing device, wherein the target interface includes a platform-neutral, open-standard connectivity interface for driving stimulation signals over the one or more connections to the information-processing device; and
software agent means in the information-processing device for parsing and directing stimulation signals received over the platform-neutral, open-standard connectivity interface with the target interface to the native operating software of the information-processing device.

22. The computerized system of claim 21, wherein the host testing system unit further includes:
a memory;
a set of stimulation commands stored in the memory for stimulating the system-under-test unit through the target interface.

23. The computerized system of claim 22, wherein the host testing system unit further includes:
an output capture device for capturing output from the system-under-test unit; and
a set of commands stored in the memory for comparing a captured output from the system-under-test unit with an expected output.

24. The host testing system unit of claim 22, wherein the set of stimulation commands stored in the memory include test commands of an automated testing tool.

25. The computerized system of claim 22, wherein the host testing system unit further includes:
a test program, created using one or more stimulation commands, for automatically testing one or more functions of the system-under-test unit;
a log file in the memory for tracking test success; and
an output device for viewing a test program result.

26. The computerized system of claim 22, wherein the host testing system unit further includes:
one or more target interfaces for one or more system-under-test units, wherein the system-under-test units are of one or more types of devices.

27. The computerized system of claim 21, wherein the platform-neutral, open-standard connectivity interface includes one or more interfaces selected from the group consisting of:
Component Object Model (COM);
Distributed Component Object Model (DCOM); and
Simple Object Access Protocol (SOAP).

28. The computerized system of claim 21, wherein the platform-neutral, open-standard connectivity interface includes one or more interfaces selected from the group consisting of:
Ethernet;
Universal Serial Bus (USB);
Electrical Industries Association Recommended Standard 232 (RS-232); and
Bluetooth™.

29. A software test agent stored in a memory for execution on an information-processing system-under-test unit, the system-under-test unit having a native operating software, stored in the memory, that controls field functions of the system-under-test unit, the software test agent comprising:
a platform-neutral, open-standard connectivity interface; and
a set of commands for execution on the system-under-test unit that parse stimulation signals received over the platform-neutral, open-standard connectivity interface and directs stimulations to the native operating software of the system-under-test unit.

30. The software test agent of claim 29, wherein the system-under-test unit is connected to a host testing system unit that drives stimulation commands in signals over the connection to test functions of the system-under-test unit.

31. The software test agent of claim 30, wherein the system-under-test outputs data, in response to the stimulation signals, that is captured by the host testing system unit for comparison with an expected output to determine a test result.

32. The method of claim 1, the method further comprising:
providing a second target interface on the host computer;
providing a second information-processing device having native operating software that includes a human interface for interacting with a human user, wherein the second device is not identical to the first device, the native operating software of the second device is not identical to the native operating software on the first device, and the human interface of the second device is not identical to the human interface of the first device;
providing a software agent in the second device, the software agent being a minimally intrusive code added to the native operating software of the second device, the software agent provided to interact with the second target interface;
sending the stimulation command from the host computer to the software agent on the second device, wherein the stimulation command is identical to the stimulation command sent to the first device;
stimulating the human interface of the native operating software of the second device by the software agent according to the stimulation command received by the software agent on the second device; and
receiving, into the host computer, output results of the stimulation of the second device.

33. The method of claim 32, further comprising:
stimulating the human interface of the native operating software of both the first and second devices by their respective software agents according to identical stimulation commands received by the software test agents on both the first and second devices, wherein the identical stimulation commands cause similar functionality to be tested on both the first and second devices.

34. The computerized system of claim 14, further comprising:
the host testing system further including:
a second output port,
a second input port,
a second target interface stored in the memory of the host testing system, the second target interface including commands for controlling stimulation signals sent to the second system-under-test unit;
a second system-under-test unit that includes:
a memory,
native operating software stored in the memory,
a software test agent stored in the memory, the software test agent including commands for stimulating the second system-under-test unit, wherein the software test agent receives stimulation signals from the host testing system unit's second target interface,
an input port, and
an output port;
a connector for carrying signals from the host testing system second output port to the second system-under-test unit input port; and
a connector for carrying signals from the second system-under-test unit output port to the host testing system second input port.
